(19) United States
(12) Patent Application Publication
(10) Pub. No.: US 2011/0101058 A1
(43) Pub. Date: May 5, 2011

(54) PIVOT MOUNT ASSEMBLY

(76) Inventor: TOM HECKMAN, Long Beach, CA (US)

(21) Appl. No.: 12/961,696

(22) Filed: Dec. 7, 2010

Related U.S. Application Data
(63) Continuation-in-part of application No. 12/473,787, filed on May 28, 2009.

(51) Int. Cl. B60R 11/00

(52) U.S. Cl. 224/401

(57) ABSTRACT

A tablet mount assembly for mounting an electronic device (e.g., an Apple® iPad®) in the cockpit of an aircraft, and more specifically on the steering control of the aircraft. The tablet mount includes a receiving piece and a pivot mount assembly that includes an upper portion and a lower portion. The upper portion is rotatable with respect to the lower portion. The upper portion includes a slot for connecting to the receiving piece, and the lower portion includes a securing mechanism and a positioning flange. The upper portion of the assembly is rotatable with respect to the lower portion, thereby allowing the electronic device to be mounted to be rotated from a portrait to a landscape orientation without removing the same from the mount. An indexing position system may be integrated between the lower and upper portions of the mount assembly and provides predetermined rotation increments for the device.

### CROSS REFERENCE TO RELATED APPLICATIONS

This application is a Continuation-in-Part of co-pending U.S. patent application Ser. No. 12/473,787 filed on May 8, 2009, the entire contents of which is incorporated herein by reference.

### BACKGROUND

1. Technical Field

The present invention relates to mounting assemblies. More particularly, it relates to a pivotable/rotatable mounting assembly for mounting an electronic device within the cockpit of an aircraft, and more specifically to the steering control (yoke) of an aircraft.

2. Description of Related Art

To date the use of maps and other navigation documents in an aviation or boating environment results in difficulties to read the same and simultaneously maintain proper operation of vehicles and respective operating systems. Currently there are systems in place that are essentially clip boards mounted to the steering wheels or other operation controls in an effort to hold the navigation documents in front of the operator of the respective vehicles.

With the age of technology, attempts have been made to provide the navigation documents in electronic form to the various vehicle operators. One example of such electronic forms in an aviation environment is referred to as an Electronic Flight Bag (EFB). The EFB is an electronic device that has a memory for storing navigation documents, and a display screen for selectively displaying the stored navigation documents in response to the user's input. The EFB device is bulky and very heavy, and cannot be simply secured to the steering controls (i.e., yoke) of an airplane. In addition, the EFB is generally rectangular in shape and can be used in both a portrait and landscape orientation. Thus there are many instances during the use of the EFB where the display can change from portrait to landscape orientation.

Current mounting capabilities of the EFB do not allow for the rotation of the same without dismounting it first. As such, when the instance occurs where the display changes from a portrait to a landscape orientation during operation, the pilot is forced to remove the EFB from its mount and/or review the same with the incorrect orientation.

In addition to special-purpose EFB devices, tablet computers are becoming popular for use in cockpits. One such tablet computer is the Apple® iPad®. The touch-screen interfaces available on many tablet computers are particularly effective for pilots. However, due to the wide variety of form factors available in tablet computers available from different manufacturers, there are additional challenges involved in mounting a stock tablet computer.

Thus, it becomes apparent that there is need for a device that can enable the mounting of an EFB device or tablet computer to the steering controls (e.g., yoke) of an aircraft so as to enable the operator (pilot) to quickly and easily rotate the same from a portrait orientation to a landscape orientation (i.e., 90 degrees) without interfering with their ability to operate the aircraft and without requiring the removal of the EFB from its mount.

### SUMMARY OF THE INVENTION

This and other aspects are achieved in accordance with the present invention, wherein an aircraft tablet mount assembly for mounting a tablet computer to the steering control of an aircraft is shown having a receiving piece configured to receive an electronic device and having one or more tension elements configured to secure the electronic device and a pivot mount assembly configured to mount the tablet mount assembly to the steering control of the aircraft, comprising. The pivot mount assembly includes an upper portion having a top surface including a receiving slot configured to receive and secure the receiving piece, a lower portion connected to the upper portion such that the upper portion is rotatable with respect to the lower portion, the lower portion having positioning flange on an underside thereof and a securing mechanism disposed along a lower edge of the lower portion, and a mounting receiver mounted on the steering control of the aircraft and configured to receive said positioning flange and said securing mechanism of said lower portion.

According to a preferred implementation the receiving piece further includes a support piece having one or more tabs configured to overhang a receiving plane of the support piece and a locking piece having one or more tabs configured to overhang a receiving plane of the support piece. The tension element includes one or more springs connecting said support piece and said locking piece configured to provide a force that draws the support piece and the locking piece together.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1a is top perspective view of the pivot mount assembly according to an implementation of the invention;

FIG. 1b is a bottom perspective view of the pivot mount assembly according to an implementation of the invention;

FIG. 1c is a top perspective view of the pivot mount assembly of FIG. 1a shown rotated 90 degrees;

FIG. 1d is a top perspective view of the pivot mount assembly of FIG. 1a shown rotated 180 degrees;

FIG. 2a is a top exploded view of the pivot mount assembly according to an implementation of the invention;

FIG. 2b is a bottom exploded view of the pivot mount assembly according to an implementation of the invention;

FIG. 3 is a plan view of the upper portion of the pivot mount assembly according to an implementation of the invention;

FIG. 4a is a bottom perspective view of the upper portion of the pivot mount assembly according to an implementation of the invention;

FIG. 4b is a cross-sectional view of the upper portion of the pivot mount assembly taken along lines B-B of FIG. 4a;

FIG. 4c is a cross-sectional view of the upper portion of the pivot mount assembly taken along lines C-C of FIG. 4a;

FIG. 4d is an enlarged view of the circled detailed portion shown in FIG. 4c;

FIG. 5a is a bottom perspective view of the lower portion of the pivot mount assembly according to an implementation of the invention;

FIG. 5b is a plan view of the lower portion of the pivot mount assembly according to an implementation of the invention;

FIG. 5c is a side view of the lower portion of the pivot mount assembly according to an implementation of the invention;

FIG. 6a is a cross-sectional view of the lower portion of the pivot mount assembly taken along line VI-VI of FIG. 5b;

FIG. 6b is an enlarged view of the circled detailed portion shown in FIG. 6a;

FIG. 7 is a cross-sectional view of the pivot mount assembly taken along lines VII-VII of FIG. 1a;

FIGS. 8a and 8b show the connection the pivot mount assembly to a receiver according to an implementation of the invention;

FIGS. 9 and 10 show the pivot mount assembly connected to the center of the yoke of an airplane controller; and

FIGS. 11 and 12 show an electronic flight bag (EFB) connected to the pivot mount assembly according to an implementation of the invention.

FIG. 13 is a top exploded view of the tablet mount assembly according to an implementation of the invention.

FIG. 14 is bottom view of the tablet computer in a tablet mount assembly connected to a pivot mount assembly.

FIG. 15 is a side view of a tablet computer in a tablet mount assembly connected to a pivot mount assembly.

### DETAILED DESCRIPTION

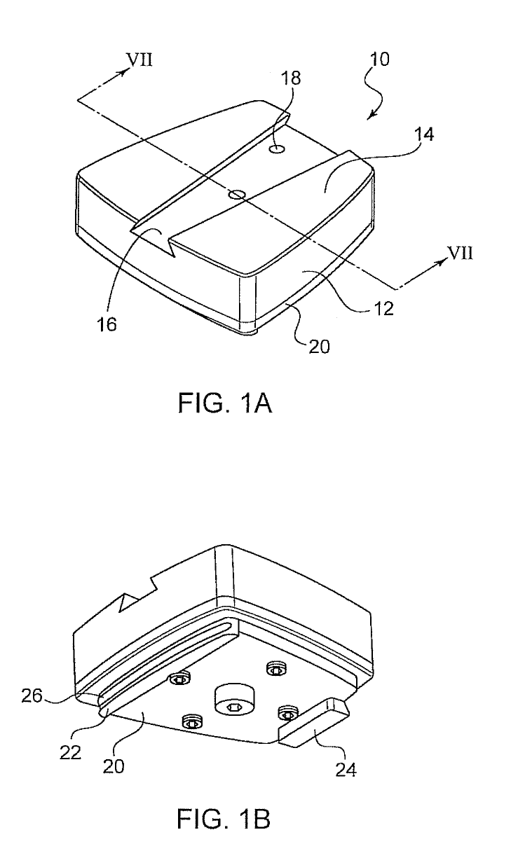

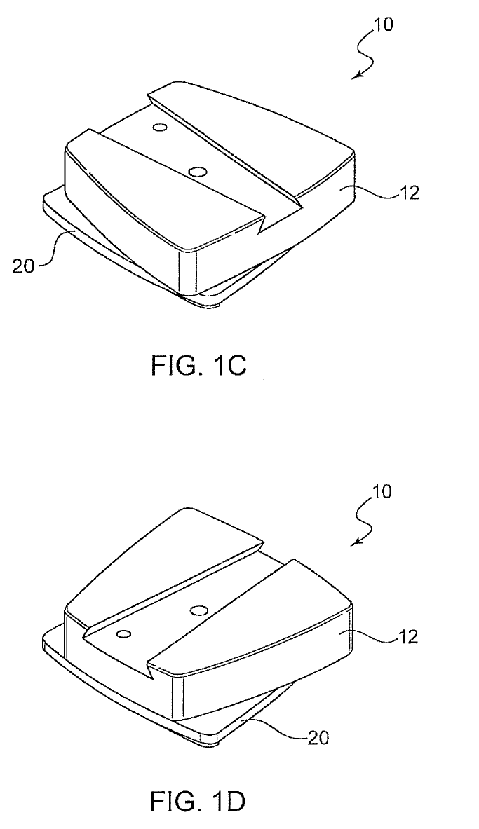

Referring to FIGS. 1a and 1b, there is shown the pivot mount assembly 10 according to a preferred implementation of the invention. Pivot mount assembly 10 is preferably made up of an upper portion 12 and a lower portion 20. The upper portion 12 includes and upper surface 14 having a receiver/mounting slot 16 for receiving a device to be pivotally mounted. Within the receiver/mounting slot 16 is one or more holes or indents 18 which assist in the securing of the device to be pivotally mounted. In this respect, the device to be mounted would preferably include a locking mechanism that would engage the one or more holes 18 in the slot 16. Alternatively, the device to be mounted can include the holes and the holes 18 in slot 16 would be replaced with a mechanism that engages the holes in the device to secure the same therein.

According to the preferred implementation, the lower portion 20 includes a position flange 24 and a locking flange 22 having a locking groove 26.

FIG. 1c shows the pivot mount assembly 10 with the upper portion 12 rotated 90 degrees with respect to the lower portion 20. FIG. 1d shows the pivot mount assembly 10 with the upper portion 12 rotated 180 degrees with respect to the lower portion 20.

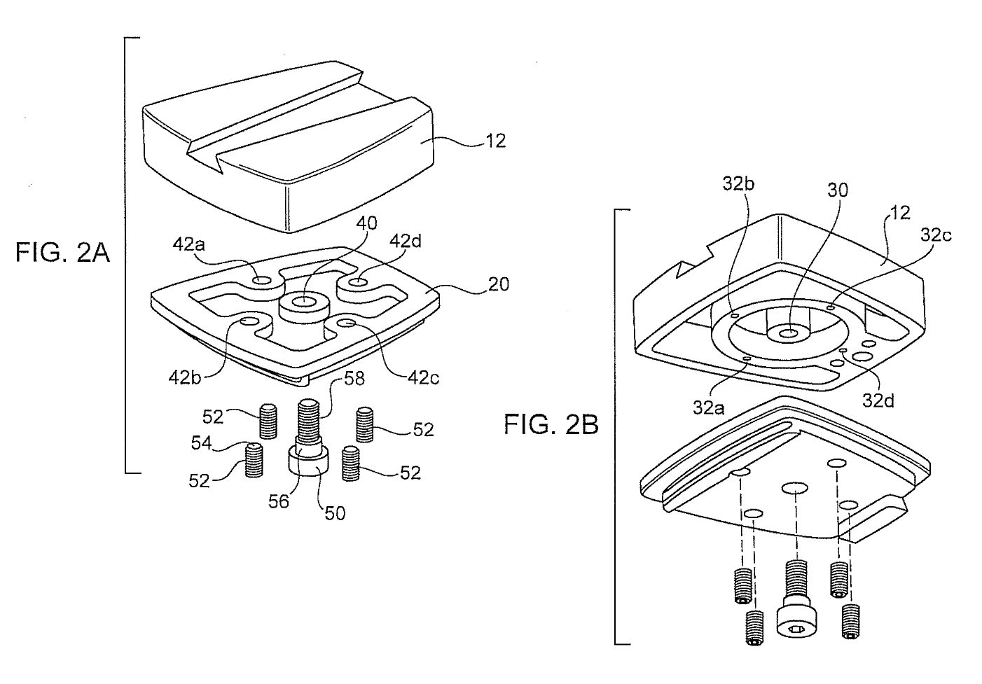

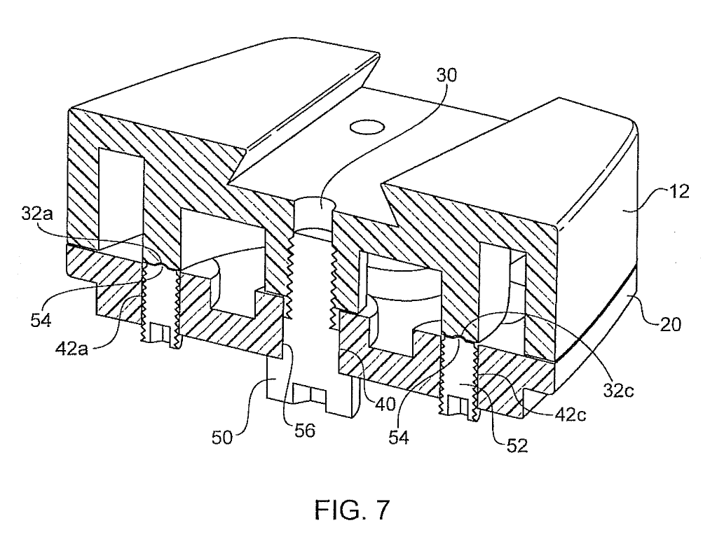

FIGS. 2a and 2b show the connection interface between the upper portion 12 and the lower portion 20 according to a preferred implementation of the invention. Lower portion 20 includes a central hole or aperture 40 for receiving a shoulder screw 50 wherein the shoulder portion 56 resides within hole 40 and the threaded portion 58 engages the central hole/aperture 30 in the upper portion 12 (See FIG. 7). In this manner, the shoulder 56 allows the upper portion 20 to rotate with respect to lower portion 20, while maintaining a secure connection between the two portions. In addition, lower portion 20 includes set holes 42-42d that receive set screws 52. Set screws 52 are unique in that they include a spring loaded ball bearing 54.

The upper portion 12 includes one or more detents 32a-32d that are positioned such that the bearings 54 of the corresponding set screw can be received into the detent and thereby provide an indexed rotatable movement of the upper portion 12 with respect to the lower portion 20. FIG. 7 shows a cross section view where the ball bearings 54 of the set screws 52 are shown in the corresponding detents 32a and 32c when the pivot mount assembly is fully assembled. Those of skill in the art will recognize that the number of detents 32 can be changed depending on the desired application. As shown with four detents in the current configuration, the upper portion is indexed to 90 degree rotations. Additional detents can be added to increase the indexed rotation options. Alternatively, detents 34 can be removed, and the friction between the ball bearings 52 of the set screws 50 can be used to provide an infinite angular rotation options. Detents 32, as used herein, can be replaced with other analogous structures, such as indentations, notches, etc. In addition, those of skill in the art will recognize that the location of the set screws and detents can be switched (i.e., between the upper and lower portions) without departing from the spirit of the present disclosure.

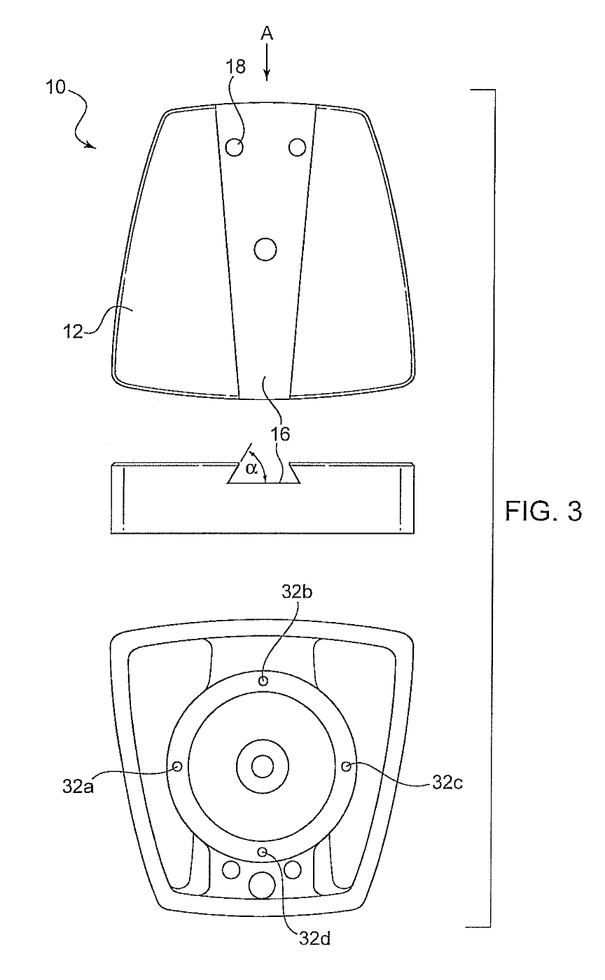

FIG. 3 shows a plan view of the upper portion 12 according to a preferred embodiment where the receiving/mounting slot 16 is shown in a tapered configuration from one end to the other, and also as having side walls with an angular configuration, such that the slot walls have an angle α which, in this example can be 60 degrees. As a result of the tapered configuration of the slot 16, the device to be mounted in the receiving/mounting slot 16 can be inserted only from one direction A as shown. According to a preferred implementation, the angular configuration of the side walls operate retain the device to be mounted (by preventing the same from being lifted out of the slot 16 in a transverse manner), and the holes (or detents) 18 can preferably be used as part of a locking or securing mechanism for securing the pivot mount assembly to the device to be mounted.

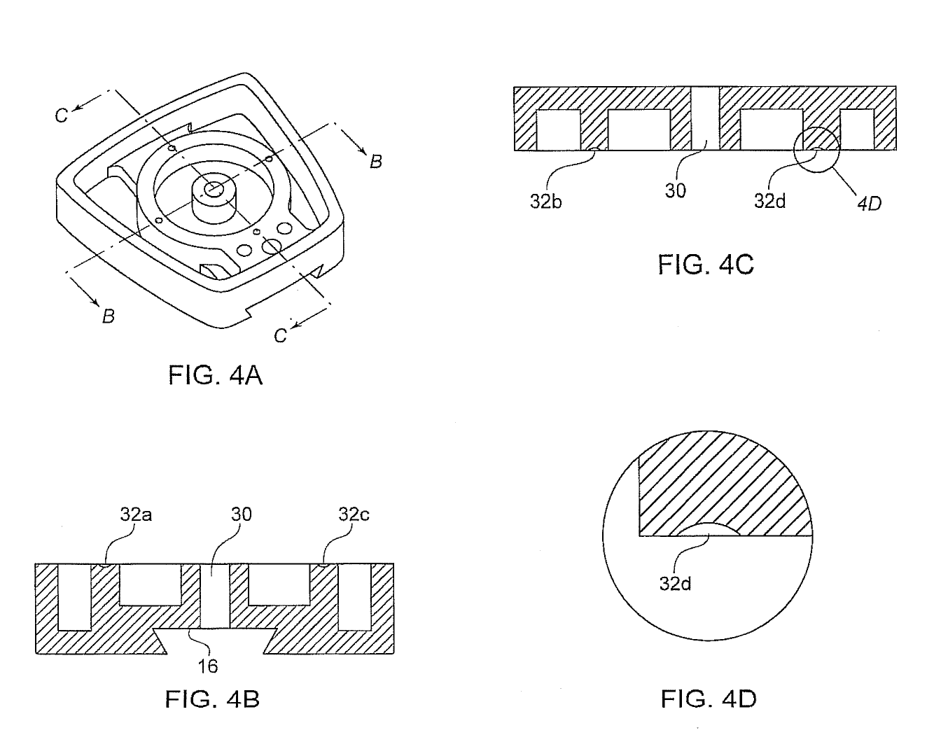

FIGS. 4a-4d shows the upper portion 12 and various cross sections according to the preferred implementation of the invention. These views show the configuration of the upper portion 12 and detents 32 that work in conjunction with the set screws 52.

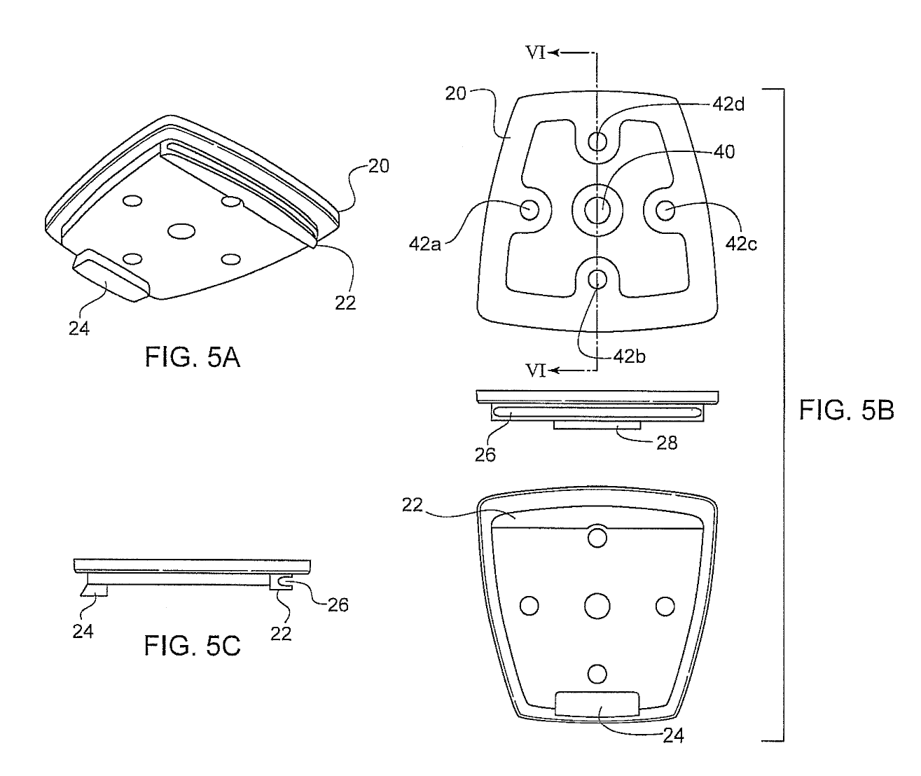

FIG. 5a-5c show the lower portion 20 according to the preferred implementation of the invention. The lower portion 20 preferably includes the position flange 24 on one side of the underside of thereof and a securing flange 22 on the opposing side. The securing flange preferably includes a securing groove 26 that can extend across the width of the corresponding side of the lower portion.

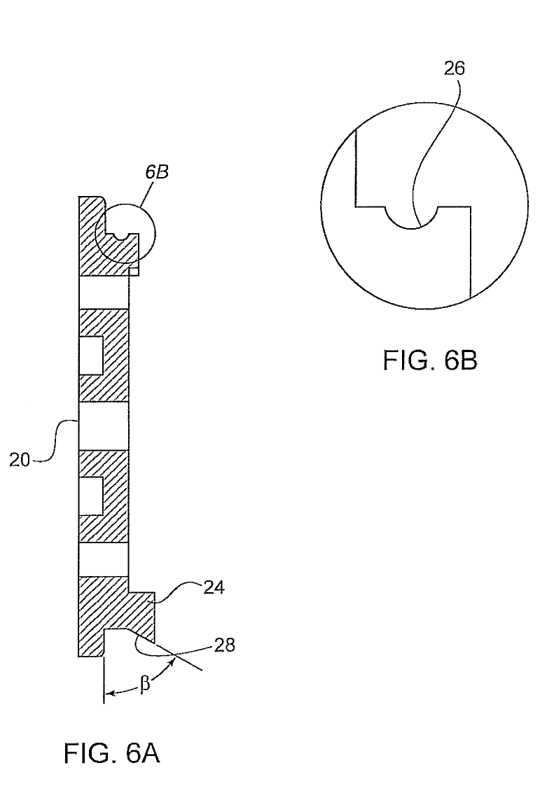

FIGS. 6a and 6b shows a cross section view of the lower portion 20 where the angular configuration of the position flange 24 is more clearly shown. The angular outer face 28 of the flange 24 preferably has an angle β that assists in the positioning of the same into a mounting receiver. The angle β can be, for example, 60 degrees.

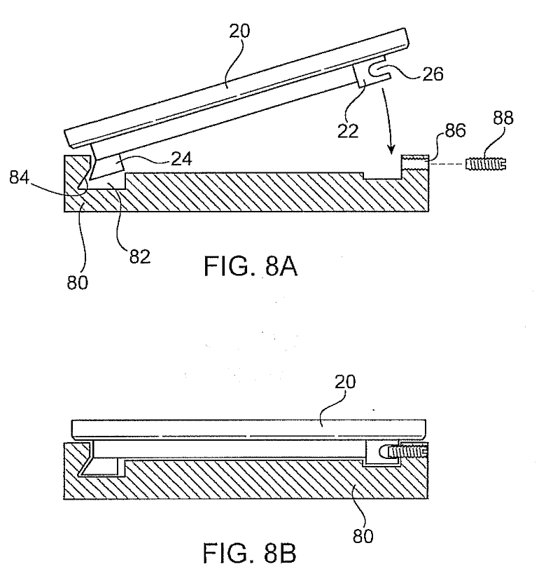

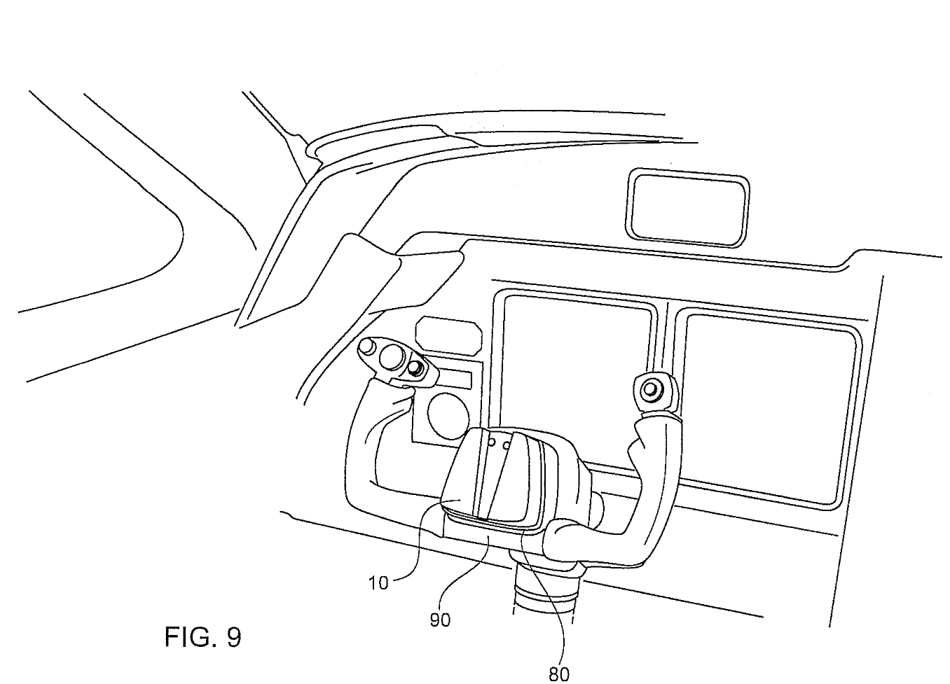

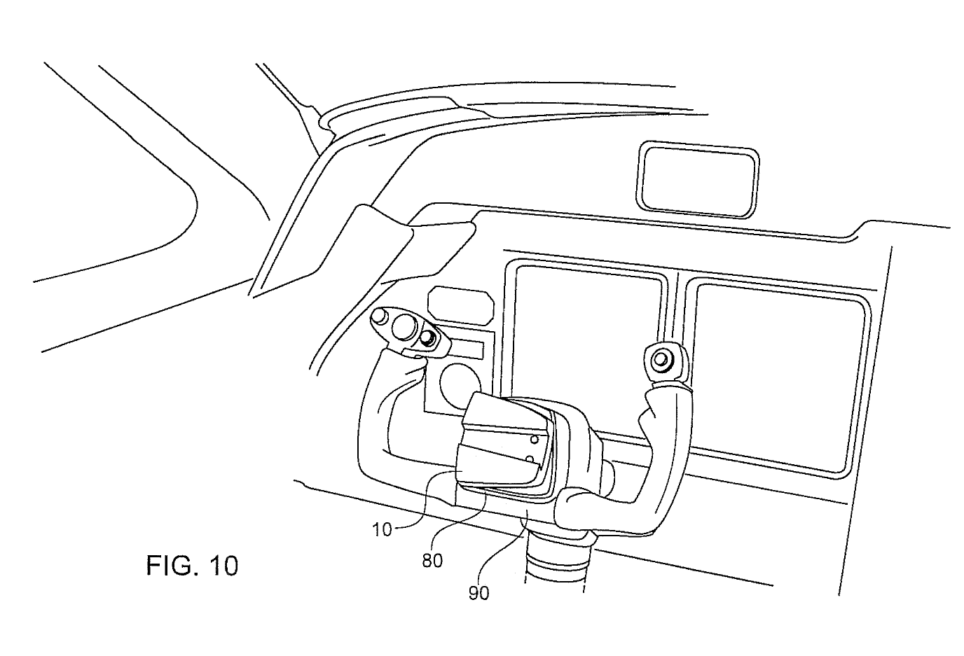

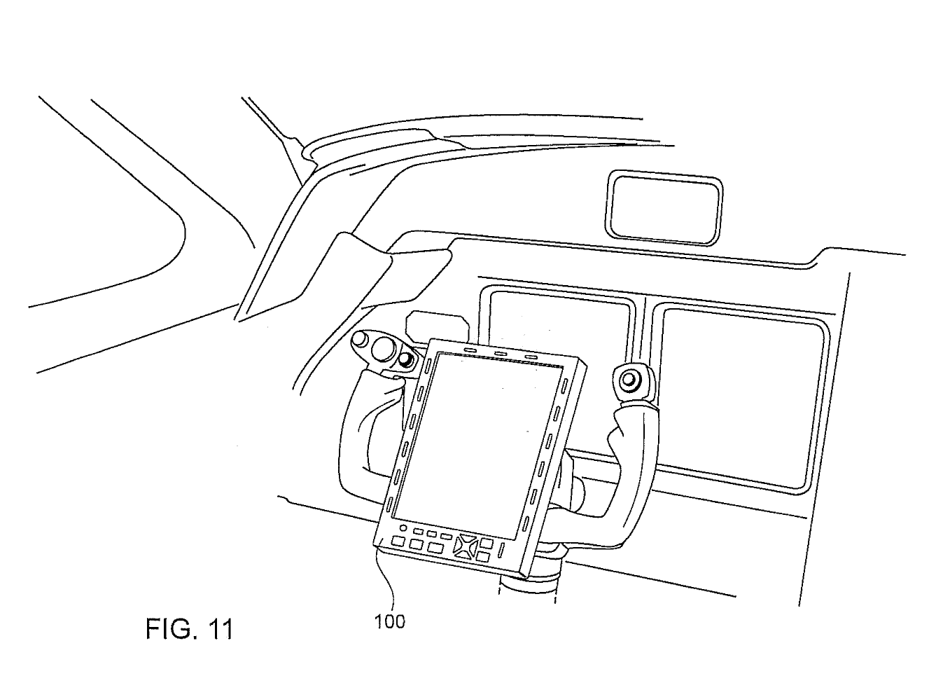

FIGS. 8a and 8b show an example of the mounting of the lower portion into a mounting receiver 80 according the preferred embodiment. In this example, the mounting receiver 80 preferably includes a slot 82 configured to receive the position flange 24 as shown in FIG. 8a where angular face 26 of the flange 24 corresponds to the angular wall 84 within the slot 82. Once flange 24 is positioned within slot 82, the locking flange 22 is pivoted downward into the mounting receiver 80 such that groove 26 is aligned with a securing screw hole 86 such that securing screw 88 can be inserted therein. FIG. 8b shows lower portion 20 secured into the mounting receiver 80. Those of skill in the art will recognize that mounting receiver 80 is shown here as an example and that such receiver shall have the appropriate accommodations so as to not interfere with the shoulder screw 50 or set screws 52 on the underside of lower portion 20.

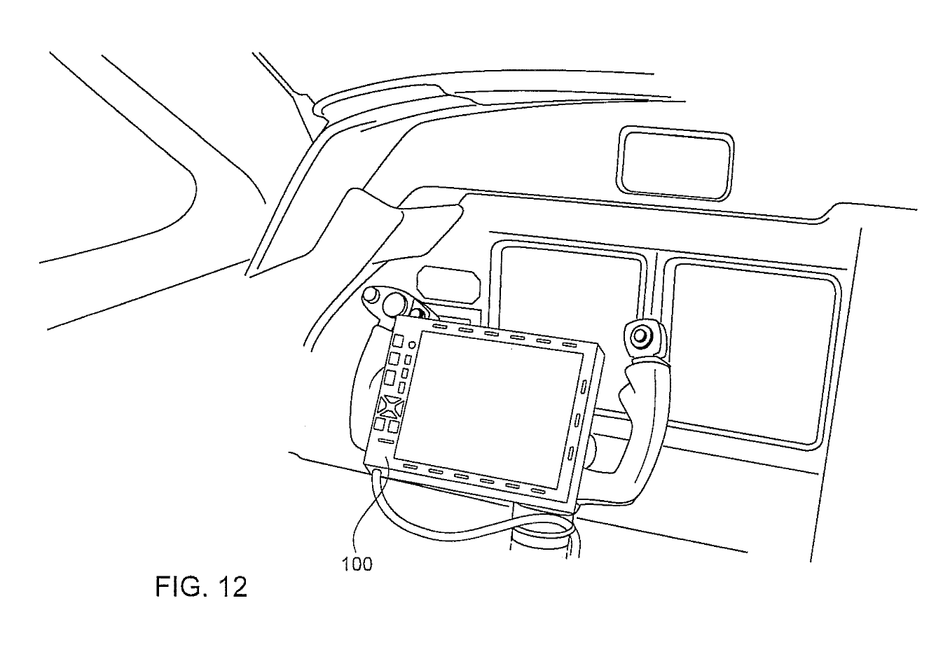

FIGS. 9 and 10 show the preferred application of the pivot mount assembly 10 in an aviation environment. As shown, the pivot mount assembly 10 is mounted to the center of the yoke 90 of a GULFSTREAM® G4 jet using a mounting receiver 80 as described above (GULFSTREAM is a registered trademark of the Gulfstream Aerospace Corporation). Although shown in the preferred implementation for a GULSTREAM jet, those of skill in the art will recognize that the pivot mount assembly of the present invention can be utilized in other aircrafts, such as, for example, commercial and cargo aircrafts and other manufacturer's private jets. FIG. 9 shows the pivot mount assembly 10 in a first position, and FIG. 10 shows the pivot mount assembly in a second position rotated 90 degrees from the first position.

In accordance with the preferred implementation of the invention, the receiving/mounting slot 16 of the pivot mount assembly 10 is configured to receive an Electronic Flight Bag (EFB) device. FIGS. 11 and 12 show an EFB 100 mounted to the pivot mount assembly of the invention in a first (portrait) position and a second 90 degree rotated (landscape) position, respectively.

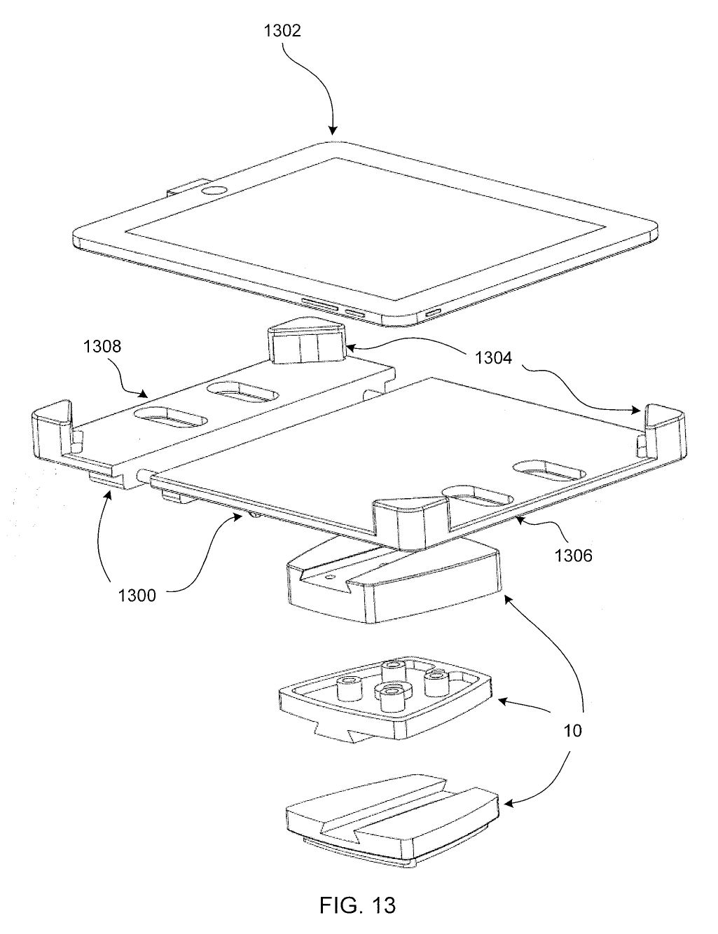

Referring now to FIG. 13, a tablet mount assembly 1300 for a tablet computer 1302 is shown. The tablet mount assembly 1300 is formed from a support piece 1306 and a locking piece 1308. The support piece 1306 and the locking piece 1308 form a receiving plane of the tablet mount assembly 1300 and each of said pieces has two locking tabs 1304. The tablet computer 1302 is placed on the support piece 1306 and the locking piece 1308, fitting underneath the locking tabs 1304. The support piece 1306 and locking piece 1308 are then brought together, such that the locking tabs 1304 cover the corners of the tablet computer 1302, holding it in place. Tablet mount assembly 1300 may be attached to pivot mount assembly 10 as shown above in FIGS. 10-12. The locking tabs 1304 may further be made adjustable, allowing for accommodation of tablets of differing thickness. The locking tabs 1304 may further have lining to prevent scratching or damage to the tablet computer 1302 during insertion, removal, and operation. Said lining may comprise, for example, a padded lining or a lining made of a slippery material such as Teflon®.

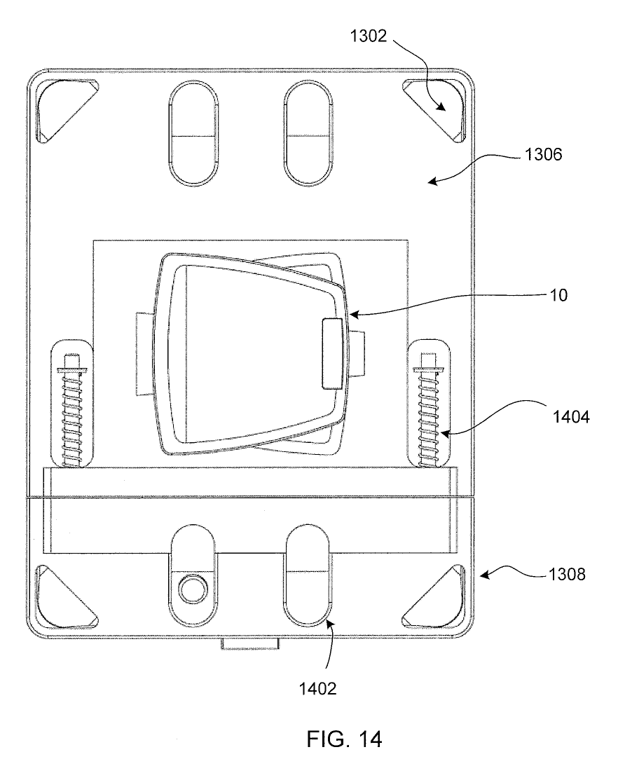

Referring now to FIG. 14, the tablet mount assembly 1300 is shown from below. The locking piece 1308 and the support piece 1306 are held together by locking springs 1404, which hold with sufficient force to keep the tablet computer 1302 firmly in place while allowing for manual removal. Although springs are shown and described herein for the purpose of illustration, it is intended that any suitable tension element may be used. To facilitate insertion and removal of tablet computer 1302, one or more finger openings 1402 are provided in the bottom of the support piece 1306 and the locking piece 1308. Finger openings 1402 are sized to allow for use by a variety of hand sizes and may have a raised ridge of plastic around their edges to facilitate grip. Finger openings may also be placed with particular tablet computer configurations in mind, allowing room for tablet components that break the plane of the tablet mount assembly. By disposing the openings in the tablet mount assembly 1300 with rotational symmetry, tablet computers 1302 having such components may be placed in the tablet mount assembly 1300 in any orientation.

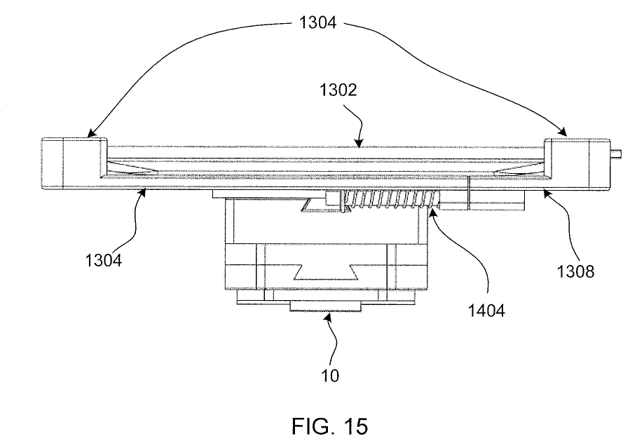

Referring now to FIG. 15, a side-on view of the tablet mount assembly 1300 is shown, illustrating the operation of the locking springs 1404. The pivot mount assembly 10 may be an assembly such as that shown above in FIGS. 1-8, but this is only one exemplary embodiment. Other embodiments, such as the pivot mount assembly shown in FIGS. 13-15, may provide additional features such as positioning along one or more axes.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested faun or implementation as a general matter of design choice. It is the intention, therefore, to be limited only as indicated by the scope of the claims appended hereto.

What is claimed is:

1. An aircraft tablet mount assembly for mounting a tablet computer to the steering control of an aircraft, comprising:
a receiving piece configured to receive an electronic device and having one or more tension elements configured to secure the electronic device; and
a pivot mount assembly configured to mount the tablet mount assembly to the steering control of the aircraft, comprising:
an upper portion having a top surface including a receiving slot configured to receive and secure the receiving piece;
a lower portion connected to the upper portion such that the upper portion is rotatable with respect to the lower portion, the lower portion having positioning flange on an underside thereof and a securing mechanism disposed along a lower edge of the lower portion; and
a mounting receiver mounted on the steering control of the aircraft and configured to receive said positioning flange and said securing mechanism of said lower portion.

2. The aircraft tablet mount assembly of claim 1, wherein the receiving piece further comprises:
a support piece having one or more tabs configured to overhang a receiving plane of the support piece; and
a locking piece having one or more tabs configured to overhang a receiving plane of the support piece.

3. The aircraft tablet mount assembly of claim 2, wherein the tension element comprises one or more springs connecting said support piece and said locking piece configured to provide a force that draws the support piece and the locking piece together.

4. The aircraft tablet mount assembly of claim 2, wherein the tabs are lined to prevent damage to the electronic device.

5. The aircraft tablet mount assembly of claim 4, wherein the tab lining comprises one of a padded lining and a Teflon® lining.

6. The aircraft tablet mount assembly of claim 2, wherein said support piece and said locking piece have one or more finger openings.

7. The aircraft tablet mount assembly of claim 1, wherein the receiving piece is removably attached to the pivot mount assembly.

8. The aircraft tablet mount assembly of claim 1, wherein the finger openings of the support piece and the locking piece are disposed in rotationally symmetric positions.

9. The aircraft tablet mount assembly of claim 1, wherein the receiving piece is configured to receive an Apple® iPad®.

10. The aircraft tablet mount assembly of claim 1, wherein said receiving slot is tapered such that the receiving piece to be mounted therein slidably engages said receiving slot from one side thereof only.
